(19) United States
(12) Patent Application Publication
(10) Pub. No.: US 2009/0106794 A1
(43) Pub. Date: Apr. 23, 2009

(54) Multidimensional Navigation on Television Monitors

(76) Inventor: Oliver Wallington, Struer (DK)

Correspondence Address: HARNESS, DICKEY & PIERCE, P.L.C., P.O. BOX 8910, RESTON, VA, 20195, US

(21) Appl. No.: 12/227,226

(22) PCT Filed: Apr. 30, 2007
(86) PCT No.: PCT/DK2007/000206

§ 371 Date: Nov. 12, 2008

Related U.S. Application Data
(60) Provisional application No. 60/803,429, filed on May 30, 2006.

(51) Int. Cl. H04N 5/445; H04N 5/66

(52) U.S. Cl. 725/38; 348/739; 348/E05.133

(57) ABSTRACT

A method of navigating between TV channels and the like and a number of stored events on a TV or monitor, where the TV channels are provided in a sequence of positions between which navigation takes place normally using a P+ and P− button on a remote control, and where one position provides access to the stored events. Navigation to the position will enable navigation between the stored events using other buttons or touch sensitive areas on the remote control. One event may be automatically provided when navigating to the position.

The present invention relates to multidimensional navigation in relation to navigation in channels and stored media information on a TV or monitor connected to a TV tuner.

More particularly, the Invention relates to a seamless incorporation and control also of stored events which are also to be provided on the TV/monitor.

Today, navigation in TV channels or between different inputs on TV's is a one-dimensional navigation using different channel number or P+ or P− buttons. An alternative to this is seen in known products from Bang & Olufsen, Denmark, in which different users of the TV may each have a list of presets (e.g. P1 . . . P99) referring to channels available to this user. Navigation between the channels of the individual user specific lists is performed using the standard P+ and P− buttons. In this manner, irrelevant or unsuitable channels may be removed from the channel list of this particular user. Selection of the user group is performed by pushing other buttons. The virtual position of the lists with preset program numbers related to channels of the users is beside each other along vertical lines.

In this respect, it is noted that the TV or monitor may define a TV channel as a channel number (e.g. UHF channel 10) or a frequency (e.g. 111 MHz). Then, a channel number or a frequency will be assigned to a preset program number of the TV or monitor. How the preset program number is assigned to the correct contents of the input to the TV or monitor is irrelevant for the present invention.

In a first aspect, the invention relates to a method of navigating between TV channels and/or other Information sources, including stored events, available to a TV or other monitor, the method comprising:
1. providing information relating to the plurality of TV channels and/or other information sources available to the TV/monitor,
2. assigning to the channels/sources a sequence for navigation there between, each channel/source having a position in the sequence,
3. navigating between the channels/sources by providing, to the TV/monitor, information relating to a direction of two opposite directions of the sequence, the TV/monitor, as a response to the navigation, providing the next channel/source in the pertaining direction, as defined by the sequence,
4. providing a number of stored events,
5. the sequence comprising a position at which one of the stored events is provided on the TV/monitor and where navigation in a second direction, which is different from any of the two opposite directions, provides access to one or more others of the stored events.

Naturally, the information provided relating to the TV channels/sources may be the actual, fed signal of the channels. Also, the information may relate to TV channels, provided wireless, via cable, or the like. Other positions in the sequence may be used for standard video or audio sources, such as CD players, HDD recorders, DVD players, VHS recorders, satellite receiver boxes, or the like.

In the present context, the sequence may be the normal channel numbers used in TV's. TV's facilitate the storing of up to a certain number of channels stored with unique program identifiers e.g. one of P1->P99, each having a position In a sequence determining navigation between the program identifiers/positions. One of these program numbers or positions may now be reserved for the stored events.

It is noted that it is irrelevant how the individual positions of the sequence is related to different parts of the signal input to the TV/monitor (whether it is defined by frequency or channel number, for example) is irrelevant for the navigation between the positions of the sequence. In fact, a predetermined relation between position and frequency/channel number is not required. Navigation along a direction of the sequence may comprise a scanning of frequencies/channel numbers in order to identify a suitable signal. In that situation, a predetermined position may be used for the stored events, or the stored events may be navigated to when reaching a predetermined frequency or channel number.

The sequence may be linear, so that upon having navigated to an end thereof, navigation toward other positions is a navigation in the other direction, or it may be circular, whereby navigation in any of the directions may continue endlessly.

A stored event may be any type of storable information relating to any type of event. Thus, stored events may be movies, films, TV/radio/cable transmissions, music, programs, pictures, images, broadcasts, or the like. Naturally, the stored events may be of the same type, or they may be mixed in any desired manner.

Naturally, the method would normally also comprise a final step of actually navigating between the stored events by navigating in the second direction.

Preferably, step 3. comprises the user activating a keyboard and the keyboard subsequently providing the navigation information for use in the TV or monitor.

In that situation, the user may activate the keyboard by activating one or more first buttons/touch sensitive surfaces on the keyboard, and the navigation in the second direction may comprise the user activating one or more other buttons on the keyboard. Thus, the same keyboard is used for navigation in the preset TV channels (the positions) and the stored events. The main difference being the two dimensions, which may be two different directions.

The keyboard may be a simple keyboard which simply provides the information for the TV or monitor via a one-way communication. Alternatively, the communication between keyboard and TV/monitor may be two-way, whereby the keyboard may be informed that the TV/monitor has received the information, or the keyboard may receive information to be provided to the user via e.g. a display of the keyboard.

Also, the keyboard may have special-purpose buttons/areas for e.g. direct selection of the predetermined position so that the user by simply activating this button/area navigates to the position at which the stored events are available.

Naturally, the actual implementation in the TV is not relevant in this relation. The main importance is how the user understands the navigation and the user interface. Thus, the directions of navigation in the sequence may be illustrated to the user by the positions or manners of operation of the buttons/areas of the keyboard (usually a remote control) which facilitate navigation in the sequence. Normally, these, first, buttons/areas are positioned in order to define a first line or plane in relation to the user interface. In that situation, the, second, button(s) or position(s) for navigation in the stored events may be positioned in relation to the first buttons so as to define a line or plane different from (preferably two intersecting lines/planes). The user interface provides the channels and the stored events in two virtual directions or dimensions.

In a particularly interesting embodiment, step 4. comprises providing the stored events on a controllable source, such as a CD, DVD, HDD, memory card/disc, VHS recorder, or the like, and step 5. then comprises controlling the controllable source to provide, when navigating to the position, a predetermined one of the events. In fact, the source may be controlled to provide the one event automatically, as soon as navigation has arrived at the predetermined position.

In any case, it is desired that the navigation in the second direction comprises controlling the controllable source to provide another of the stored events. As is the case with the sequence of positions, navigation between the stored events may be linear or circular.

In order to inform a viewer that multiple stored events are available at the predetermined position, the navigation to the position, in step 5., preferably comprises providing, on the TV/monitor, information illustrating that navigation in the second direction is possible.

In addition, information relating to each of the events may be provided together while, or before, providing the event. This information may describe the event, such as a title of a movie/song, a description of an image, or the like. The information may be stored with the event at the time of storing of the event. The information may be derived from a TV signal at the time of storing a TV broadcast/movie or may be derived from other sources, such as an EPG or the WWW, such as by using the keyboard for requesting the information. Alternatively, It may be possible for a user to provide the information by entering it using the keyboard.

A second aspect of the invention relates to a TV or monitor comprising:
1. means for receiving a plurality of TV channels and/or information from other information sources,
2. means for assigning to the channels/sources a sequence for navigation there between, each channel/source having a position in the sequence,
3. means for navigating between the channels/sources by providing, to the TV/monitor, information relating to a direction of two opposite directions of the sequence, the TV/monitor being adapted to, as a response to the navigation, provide the next channel/source in the pertaining direction, as defined by the sequence,
4. means for storing and providing a number of events,
5. means for, when having navigated to a predetermined position in the sequence, providing one of the stored events on the TV/monitor, and
6. means for navigating in a second direction, which is different from any of the two opposite directions, and for providing access to one or more others of the stored events.

As mentioned above, the sequence may be linear or circular.

Preferably, the navigation means 3. comprises a keyboard comprising touch sensitive buttons and/or areas. The keyboard may interact with the TV/monitor over a wired link or a wireless link. The communication may be one-way or two-way as described above.

In that situation, the navigation means 3. may comprise one or more first buttons or touch sensitive areas on the keyboard, and wherein the navigation means 6. comprises one or more other buttons/areas on the keyboard.

Also, preferably the storing means 4. are adapted to provide a predetermined one of the stored events, when the navigation means 3. navigate to the predetermined position. In one embodiment, the event is automatically provided when navigating to the predetermined position. In another situation, an overview of available events may be provided in order for a user to select a desired event.

The selection or determination of an event to be provided automatically may be performed on the basis of any criteria, such as the event stored the latest.

Preferably, the navigating means 5. are adapted to control the storing means 4. to provide another one of the stored events, if e.g. that provided firstly is not that desired.

In one embodiment, the TV/monitor further comprises means for, when navigating to the predetermined position of the sequence, providing, on the TV/monitor, information illustrating that navigation in the second direction is possible.

In general, the one or more positions of the sequence at which stored events are available may be defined at any point in time. This definition may be performed by sales staff or technicians at the time of sale or delivery of the TV/monitor or may be performed subsequently by the user or a technician. The setting up may be performed using a keyboard attached to the TV/monitor, a remote control, a computer communicating with the TV/monitor (over a serial, parallel, USB, or firewire connection or the like), or may be performed using a computer communicating with the TV/monitor over the WWW.

When wishing to store an event, the TV/monitor may be able to determine a type of the event in order to determine where to make the event available. This is relevant when different positions make stored events available and where different positions make different types of events available. Also, the selection of a first event to be provided may be made on the basis of this information. This information may be derived from the event itself, from the user, an EPG, or the WWW, depending on the actual type of event and the source from which it is received or copied.

In the following, a preferred embodiment will be described In relation to the drawing, wherein:

FIG. 1 illustrates a first embodiment of a menu structure of the invention,

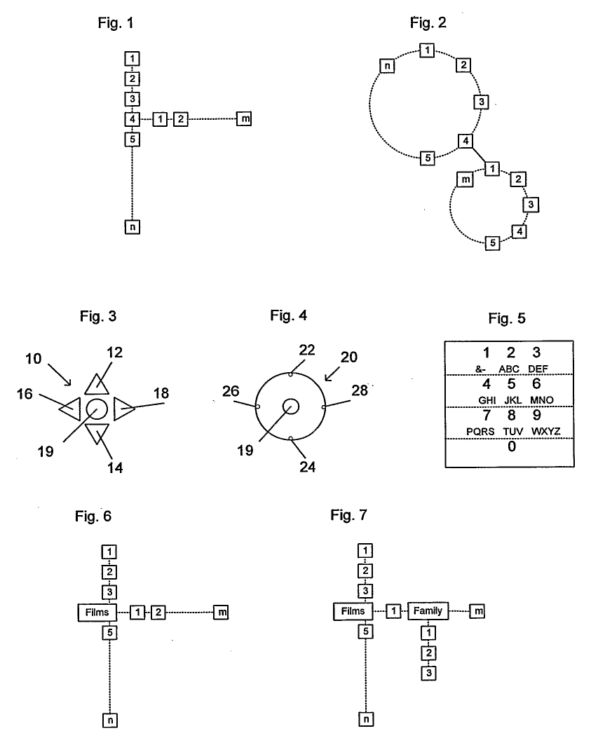

FIG. 2 illustrates a second embodiment of a menu structure of the invention,

FIG. 3 illustrates a first embodiment of a navigation keyboard,

FIG. 4 illustrates a second embodiment of a navigation keyboard,

FIG. 5 illustrates a third embodiment of a navigation keyboard,

FIG. 6 illustrates an example of a level and navigation structure of the Invention,

FIG. 7 illustrates an example of a more complex level and navigation structure of the invention, and

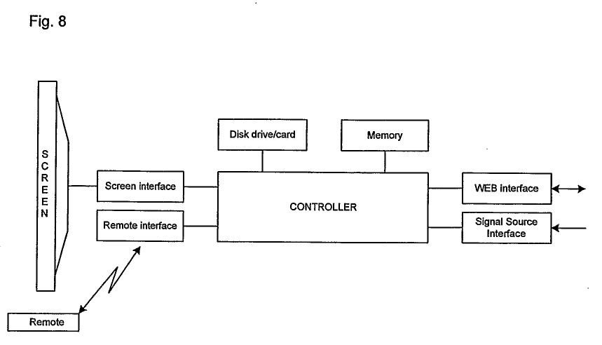

FIG. 8 is a block diagram of an example of a system for carrying out the invention.

The overall invention relates to a seamless integration also of sources of stored events, such as movies, news programs, soap operas, sports events, music, pictures/images/photos, or the like, into the program sequence of a TV or other monitor adapted to provide TV to a person or user.

In standard TV's, the available TV channels are received at a number of different frequencies or channel numbers and are each assigned a program number or position in a sequence, so that the user may change channels (zapping) merely by using the normal buttons on the remote control (P+/P− buttons). In the following, the invention will be described in relation to the positions in the sequence. How the individual frequencies or channel numbers are assigned a position in the sequence is not relevant in this relation.

The usual manner of integrating these stored events is to assign a position to a storage means, such as a CD/DVD-player, a video recorder, a hard disc (HDD) recorder or the like, whereby this storage means, once the correct position has been selected on the TV, is separately operated in order to provide or output a stored event. The actual stored event must be selected on the storage means, usually using a level and navigation structure different from that of the TV.

Referring to FIG. 1, a first embodiment is seen in which a vertical sequence of positions 1 . . . n illustrates the normal sequence of channels on a TV. Some or most of these channels may be used for the normal TV/cable TV channels, such as CNN, CBS, BBC a.s.o.

Navigation between these channels usually is performed by pressing buttons, such as P+/P− buttons on the TV or remote control, whereby the TV will shift to the position being one higher or lower, compared to the actual TV position. Alternatively, a numeric keyboard may be used for selecting any position immediately by entering the number thereof, if the desired preset or position number of a channel is known.

One position, in the present embodiment position 4, is. selected for stored events, which are represented as a horizontal list 1 . . . m of 1 . . . m events. Selecting position 4 in the channel list makes the events 1 . . . m available.

In one embodiment, selecting position 4 will result in the TV or monitor presenting an overview of the events 1 . . . m available. Subsequent selection between these events may then be performed as described further below.

In another embodiment, a selected one of the events 1 . . . m is automatically provided, once position 4 is selected. Selecting another of the events may then be performed by navigating as described further below. The selection of the event to be firstly provided may be performed on the basis of a number of criteria, such as the latest stored event, or an event fulfilling other requirements, optionally previously input or selected by the user.

In FIG. 1, the sequences 1 . . . n and 1 . . . m are illustrated as being linear, but most often these are circular in the manner that pressing P+while watching position n will provide position 1. This situation may be seen in FIG. 2, where both sequences are illustrated as being circular.

The actual navigation in the sequences may be seen in FIG. 3 which illustrates a first keyboard 10, or at least part thereof, having two vertically directed arrow buttons 12 and 14 for navigation in the position sequence 1 . . . n, as the normal P+ and P− buttons. Additionally, the keyboard 10 has two horizontally directed arrow buttons 16 and 18 for navigation in the events 1 . . . m when this is possible. Thus, navigating in the above overview to the desired event, and then optionally using the button 19 for selecting the desired event, may be performed using these buttons. Alternatively, a buttons 16/18 may be used during watching/listening to one event in order to shift to the next (or previous) event.

Naturally, the keyboard may be part of the TV or be adapted to provide information to the TV, such as is known from remote controls.

FIG. 4 illustrates another type of keyboard in which the buttons 12/14 of FIG. 3 have been replaced by a rotatable wheel or a touch pad 20 which may be rotated to alter channel number (shift between positions 1 . . . n), or positions 22-28 may be used in the same manner as the buttons 12-18 of FIG. 3.

The keyboard of FIG. 5 is a standard numerical keyboard which may be used for entering a channel/position number, a preset number or a station frequency number. Also, individual buttons may be defined for shifting between stored events and for selecting an event, for example. In addition, the keyboard may have a button/area which provides the position (here, position 4) which makes the stored events available. In fact, multiple such buttons/areas may be provided each for navigating directly to positions where stored events are available; these buttons/areas may be named after contents of the events stored.

The present Invention may define as complex a level and navigation structure as desired.

In one example, multiple positions may be defined for stored events, where different users may control the viewing/listening and storing to a given position, or positions may be defined for particular types of events: action movies, holiday pictures, children's programs, news, pop music, or the like.

In this respect, events may, when stored or a storage program is set up, be assigned to a particular event group or position in the sequence either by a user or based on its contents.

In FIG. 6, a group of stored events—on position 4—is named “Films”, and this channel/group heading may be presented when navigating to position 4 via the normal TV position 1 . . . n.

In FIG. 7, a more complex level and navigation structure is illustrated in which a position of the sequence under the “Films” group again is a group of “Family” films. Thus, firstly navigating through positions 1 . . . n to the “Films” channel, navigation may be performed horizontally, until the “Family” group is encountered. In that situation, navigation downward (or upwards for a circular sequence of “Family” films) will present the user with different films from the “Family” group. Navigating further right (or left) will present the user with the films in the horizontal group 1 . . . m of films. As mentioned above, once encountering the “Family” group when navigating in the “Films” group may bring about a notice on the TV or monitor that navigation is now possible in more than one direction or plane.

An alternative to the structure illustrated in FIG. 7 may be one in which the “Family” group may be presented at one of the positions 1 . . . n by itself.

It may be desirable to provide, on the keyboard, a button which, when pressed, makes the TV illustrate an overview of the different groups, possible navigation directions

FIG. 8 provides a block diagram of elements of a system embodying the present invention. This system comprises a Signal Source Interface for receiving the TV signals from any source, such as a cable network, an aerial, a Satellite Receiver box or the like. This signal is fed to a controller again feeding a selected channel to a Screen interface and onto the Screen.

The controller receives instructions from a Remote Interface in wireless connection with a Remote Control in the usual manner.

The Controller also is in contact with a memory. This memory may be used for holding the software controlling the controller and events stored from e.g. Signal Source Interface (stored TV programs or the like). Stored events may also be provided from a disk Drive or Card reader, which may hold removable or replaceable memories storing one or more events.

The actual operation of the system is controlled by the Remote Control via the Controller, and these elements may define the sequence of channels and allocating program identifiers/positions of the system, where a number of the positions of the events are used by TV channels received via the Signal Source Interface.

One position at least is used for navigating in the stored events stored in the memory and/or the Disk Drive or Memory card. The navigation in the sequence of positions, preset program numbers/identifiers and between the stored events may be carried out as described further above.

Finally, the present system comprises a Web Interface via which the controller may be set up and the individual positions for use in relation to stored events may be set up or modified. In addition any categories (such as contents) of stored events to be provided by the individual positions of the sequence may be altered or set up.

Also, the Web Interface may be used for programming the controller to facilitate storing of particular TV programs or the like or for providing events to be downloaded and stored in the memory/Disk Drive/Card reader. When storing an event, additional information may be derived relating to the event. This Information may describe the event and may be used for providing the event in the correct event group, if multiple groups have been defined. In addition, the information may be provided on the IV/monitor when providing the event in order for the user to quickly determine whether to experience that event or to navigate to another event.

This information may be derived from the event itself (a TV programme, a song or the like) or from other sources, such as the user, EPG's or from the WWW via a web connection of the TV/monitor.

Naturally, the set-up of one TV/monitor may be copied to other TV's or monitors in order to have all products in one household identical or in order to quickly provide a basic set-up of the product. This copying may be performed via a computer connected to the products, via the WWW, or via e.g. removable memory units connectable to the products. The same manners may be used for correcting the current set-up by providing the desired set-up and copy it to the actual TV/monitor.

1-12. (canceled)

13. A method of navigating between TV channels and/or other information sources, including stored events, available to a TV or other monitor, the method comprising:
1. providing information relating to the plurality of TV channels and/or other information sources available to the TV/monitor,
2. assigning to the channels/sources a sequence for navigation there between, each channel/source having a position in the sequence,
3. navigating between the channels/sources by providing, to the TV/monitor, information relating to a direction of two opposite directions of the sequence, the TV/monitor, as a response to the navigation, providing the next channel/source in the pertaining direction, as defined by the sequence,
4. providing a number of stored events, and
5. the sequence comprising a position at which one of the stored events is provided on the TV/monitor and where navigation in a second direction, which is different from any of the two opposite directions, provides access to one or more others of the stored events.

14. A method according to claim 13, wherein step 3. comprises the user activating a keyboard and the keyboard subsequently providing the information.

15. A method according to claim 14, wherein the user activates the keyboard by activating one or more first buttons and/or touch sensitive areas on the keyboard, and wherein the navigation in the second direction comprises the user activating one or more other buttons and/or touch sensitive areas on the keyboard.

16. A method according to claim 13, wherein step 4. comprises providing the stored events on a controllable source, and wherein step 5. comprises controlling the controllable source to provide, when navigating to the position, a predetermined one of the events.

17. A method according to claim 16, wherein the navigation in the second direction comprises controlling the controllable source to provide another of the stored events.

18. A method according to claim 13, wherein the navigation to the position, in step 5, comprises providing, on the TV/monitor, information illustrating that navigation in the second direction is possible.

19. A TV or monitor comprising:
1. means for receiving a plurality of TV channels and/or information from other information sources,
2. means for assigning to the channels/sources a sequence for navigation there between, each channel/source having a position in the sequence,
3. means for navigating between the channels/sources by providing, to the TV/monitor, information relating to a direction of two opposite directions of the sequence, the TV/monitor being adapted to, as a response to the navigation, provide the next channel/source in the pertaining direction, as defined by the sequence,
4. means for storing and providing a number of events,
5. means for, when having navigated to a predetermined position in the sequence, providing one of the stored events on the TV/monitor, and
6. means for navigating in a second direction, which is different from any of the two opposite directions, and for providing access to one or more others of the stored events.

20. A TV/monitor according to claim 19, wherein the navigation means 3. comprises a keyboard.

21. A TV/monitor according to claim 20, wherein the navigation means 3. comprises one or more first buttons and/or touch sensitive areas on the keyboard, and wherein the navigation means 6. comprises one or more other buttons and/or touch sensitive areas on the keyboard.

22. A TV/monitor according to claim 19, wherein the storing means 4. are adapted to provide a predetermined one of the stored events, when the navigation means 3. navigate to the predetermined position.

23. A TV/monitor according to claim 22, wherein the navigating means 5. are adapted to control the storing means 4. to provide another one of the stored events.

24. A TV/monitor according to claim 19, further comprising means for, when navigating to the predetermined position of the sequence, providing, on the TV/monitor, information illustrating that navigation in the second direction is possible.
